(19) United States
(12) Patent Application Publication
(10) Pub. No.: US 2013/0147436 A1
(43) Pub. Date: Jun. 13, 2013

(54) BATTERY PACK AND ELECTRONIC PAYMENT SYSTEM

(71) Applicant: Masaaki Fukumoto, Anjo-shi (JP)

(72) Inventor: Masaaki Fukumoto, Anjo-shi (JP)

(73) Assignee: MAKITA CORPORATION, Anjo-shi, Aichi (JP)

(21) Appl. No.: 13/818,905

(22) PCT Filed: Aug. 24, 2011
(86) PCT No.: PCT/JP2011/069051

§ 371 Date: Feb. 25, 2013

(30) Foreign Application Priority Data
Sep. 2, 2010 (JP) 2010-196858

(51) Int. Cl. H02J 7/00

(52) U.S. Cl. CPC H02J 7/00
USPC 320/127

(57) ABSTRACT

A battery pack of the present invention is a battery pack for an electric power tool, which is to be detachably attached to the electric power tool to supply electric power to the electric power tool. The battery pack includes a battery unit that can be charged and discharged, and a fee calculation information detection unit that detects information for calculating a usage fee in accordance with use of the electric power tool.

### CROSS-REFERENCE TO RELATED APPLICATIONS

This international application claims the benefit of Japanese Patent Application No. 2010-196858 filed Sep. 2, 2010 in the Japan Patent Office, and the entire disclosure of Japanese Patent Application No. 2010-196858 is incorporated herein by reference.

### TECHNICAL FIELD

The present invention relates to a battery pack for an electric power tool, which is to be detachably attached to the electric power tool to supply electric power to the electric power tool.

### BACKGROUND ART

For example, the battery charger as set forth in Patent Document 1 is enabled to charge an electric power tool by inserting a billing card into a card reader or feeding cash into a cash entry slot.

### PRIOR ART DOCUMENTS

### Patent Documents

Patent Document 1: JP10307961

### SUMMARY OF THE INVENTION

### Problems to be Solved by the Invention

Incidentally, a battery pack to be detachably attached to an electric power tool is expensive and, in addition, such a battery pack (especially, a battery unit) is an expendable article. Therefore, a user is forced to bear considerable costs for purchasing and maintaining the electric power tool.

In view of the above, an object of the present invention is to provide a device that enables the user to suppress the costs for purchasing and maintaining the electric power tool.

### Means for Solving the Problems

In order to achieve the above object, a battery pack according to a first aspect of the present invention includes a battery unit that can be charged and discharged, and is to be detachably attached to an electric power tool to supply electric power to the electric power tool; and a fee calculation information detection unit that computes information for calculating a usage fee in accordance with use of the electric power tool.

Due to this, in the first aspect of the present invention, at least as for the battery pack in the electric power tool, a manufacturer (a distributor) can charge a usage fee in accordance with use of the electric power tool. Therefore, it becomes possible for the user to suppress costs for purchasing and maintaining the electric power tool.

In a second aspect of the present invention, the battery pack may further include a payment information storage unit and a charge/discharge control unit. In the payment information storage unit, a payment information about the usage fee is stored. The charge/discharge control unit calculates the usage fee based on a detection result from the fee calculation information detection unit, and permits or prohibits at least either of a discharge operation and a charge operation of the battery unit based on the calculated usage fee and the payment information stored in the payment information storage unit.

In a third aspect of the present invention, the charge/discharge control unit may determine whether or not the calculated usage fee has been already paid based on the payment information stored in the payment information storage unit, and decide to permit or prohibit the operation.

In a fourth aspect of the present invention, the charge/discharge control unit may determine whether or not the calculated usage fee exceeds an already-paid amount based on the payment information stored in the payment information storage unit, and when the charge/discharge control unit determines that the calculated usage fee exceeds the already-paid amount, an information indicating an excess usage fee may be stored.

In a fifth aspect of the present invention, the battery pack may further include a connection unit for a readable/writable connection to the payment information storage unit.

Furthermore, an electronic payment system according to a sixth aspect of the present invention includes the battery pack according to any of the second to fifth aspects of the present invention; and a computer that performs an information communication with the battery pack.

### BRIEF DESCRIPTION OF THE DRAWINGS

FIG. 1 is a block diagram showing an overview of an electronic payment system.

FIG. 2 is a graph showing a billing system.

FIG. 3 is a schematic diagram showing a connection relationship between a battery pack and an electric power tool.

FIG. 4 is a schematic diagram showing a connection relationship between the battery pack and a battery charger.

FIG. 5 is a schematic diagram showing a connection relationship between a battery pack according to the first embodiment of the present invention and a service terminal and the like.

FIG. 6 is a schematic diagram showing a connection relationship between a battery pack according to the third embodiment of the present invention and a service terminal and the like.

### EXPLANATION OF REFERENCE NUMERALS

1 . . . electric power tool, 2 . . . electric motor, 3 . . . manual switch, 4 . . . control switch, 5 . . . discharge control unit, 6 . . . electric power circuit, 10 . . . battery pack, 11 . . .b attery unit, 12 . . . use history storage unit, 12A . . . detection unit, 12B . . . storage unit, 13 . . . payment information storage unit, 14 . . . charge/discharge control unit, 15 . . . connection unit, 20 . . . battery charger, 21 . . . control switch, 22 . . . charge control unit, 22 . . . control switch, 30 . . . computer, 40 . . . service terminal, 41 . . . data communication unit

### MODE FOR CARRYING OUT THE INVENTION

In the embodiments, a battery pack for an electric power tool according to the present invention is used in an electronic payment system. Hereinafter, the embodiments of the present invention will be described with reference to the drawings.l

### First Embodiment

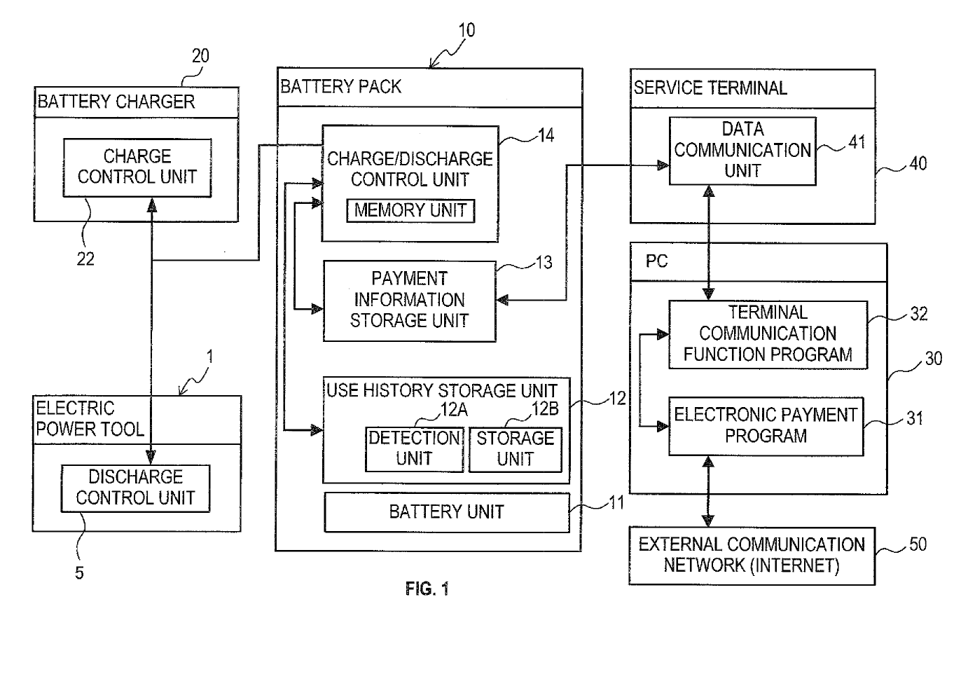

### 1. Overview of Electronic Payment System (see FIG. 1)

An electronic payment system according to the present embodiment is intended to suppress costs for purchasing and/or maintaining an electric power tool 1 (including a battery pack 10) by making payment of a usage fee for the battery pack 10 in accordance with use of the electric power tool 1 through an electronic process, instead of incurring costs for purchasing the battery pack 10.

The electronic payment system includes the battery pack 10, a computer 30, a service terminal 40, and the like. The computer 30 is connected to an external communication network 50 such as the Internet to perform information communication. The service terminal 40 is used to connect the computer 30 to the battery pack 10.

In the present embodiment, an electronic payment program 31 and a terminal communication function program 32 are installed in the computer 30. The electronic payment program 31 makes payment via a communication network connection. The terminal communication function program 32 performs information communication with the battery pack 10 via the service terminal 40. In the service terminal 40, a data communication unit 41 is incorporated which relays the information communication between the battery pack 10 and the computer 30.

The battery pack 10 is configured to include a battery unit 11, a use history storage unit 12 (hereinafter also referred to as “a storage unit 12”), a payment information storage unit 13 (hereinafter also referred to as “a storage unit 13”), a charge/discharge control unit 14 (hereinafter also referred to as “a control unit 14”), and the like.

The battery unit 11 is composed of a secondary battery that can be charged and discharged.

The storage unit 12 detects a use history such as input/output current, temperature, and the like of a battery, and stores the use history. Specifically, the storage unit 12 includes a detection unit 12A and a storage unit 12B. The detection unit 12A detects input/output current value, current-carrying time, voltage value at the time of current input/output, and temperature of the battery unit 11. The storage unit 12B stores the detected values and a type of the battery unit 11.

The storage unit 13 stores payment information about the usage fee. More specifically, the storage unit stores payment information such as a chargeable amount and a dischargeable amount for which payment has been already made.

The control unit 14 permits or prohibits a discharge operation and a charge operation of the battery unit 11. More specifically, the control unit 14 outputs a charge permission signal and/or a discharge permission signal based on the payment information about the usage fee and the use history.

The electric power tool 1, the storage unit 12, the storage unit 13, and the control unit 14 receive power supply from the battery unit 11.

The storage unit 12 (the storage unit 12B) and the storage unit 13 are readable/writable storage devices, and each is composed of a non-volatile storage device (for example, a flash memory) capable of retaining information even in a state where power supply is stopped.

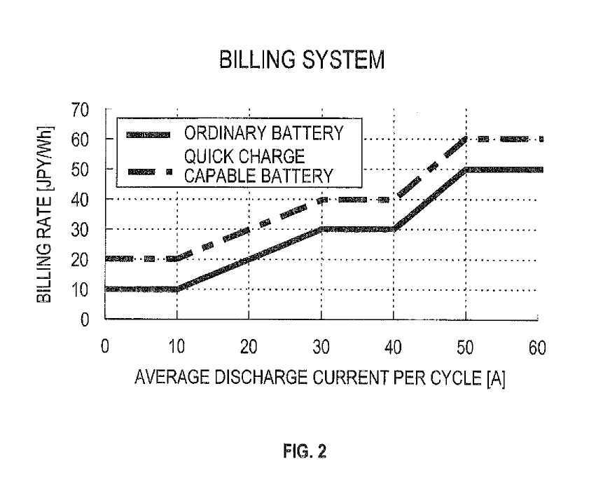

The control unit 14 calculates the usage fee based on the information such as the current value stored in the storage unit 12 and a fee map (see FIG. 2) etc., and controls charge/discharge of the battery unit 11 by comparing the calculated usage fee with the payment information stored in the storage unit 13. A specific charge/discharge control process will be described later.

The fee map, a program to operate the control unit 14, and the like are stored in advance in a non-volatile storage device (hereinafter referred to as a memory unit) provided in the control unit 14.

2. Calculation of usage fee (see FIG. 2)

During use of the electric power tool 1, when discharge load (use load) of the battery pack 10 becomes large, the battery pack 10 (the battery unit 11) is more likely to deteriorate early compared to a case where the discharge load is smaller.

Therefore, in the present embodiment, the usage fee is decided with weights assigned in accordance with the use load, instead of being decided linearly (proportionally) with respect to a used electric energy. Specifically, a period from when the battery pack 10 is in a fully charged state till when the battery pack 10 is brought into a deep discharge state is defined as one cycle, and a billing rate is changed in accordance with an average discharge current per cycle, to thereby decide the usage fee with weights assigned in accordance with the use load.

Specifically, in the battery pack 10 of ordinary type, as shown by a solid line in the graph of FIG. 2, when the average discharge current per cycle is 10 A or less, the billing rate is 10 (JPY/Wh), and when the average discharge current per cycle is 30 A, the billing rate is 30 (JPY/Wh).

In a case of the battery pack 10 of quick charge capable type, which can be charged in a shorter time, manufacturing costs of the battery unit 11 are higher than those of the battery pack 10 of ordinary type. Therefore, in the present embodiment, as shown by a dot-and-dash line in the graph of FIG. 2, the billing rate of the battery pack of quick charge capable type is set to be higher than that of the battery pack of ordinary type.

Consequently, the control unit 14 decides the average discharge current per cycle and the type of the battery pack 10 (whether or not the battery pack 10 is of quick charge capable type) based on the information stored in the storage unit 12. Then, the control unit 14 decides the billing rate based on the map shown in FIG. 2, and calculates the usage fee based on the used electric energy.

3. Charge/Discharge Control (Permission or Prohibition of Discharge Operation and Charge Operation of the Battery unit 11)

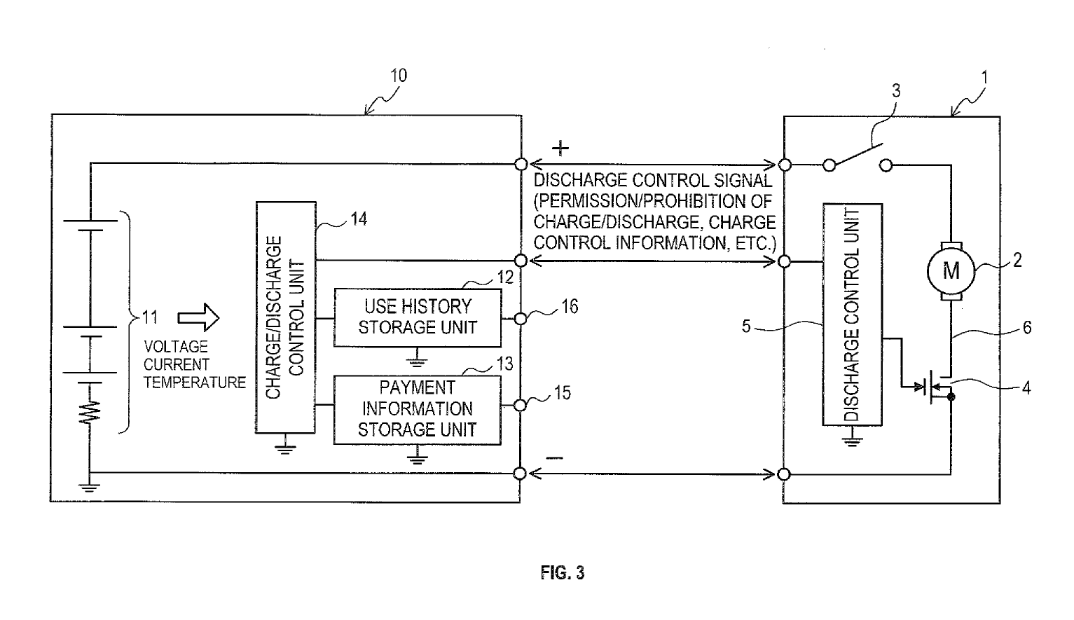

### 3.1. Discharge Control (see FIG. 3)

The electric power tool 1 includes an electric motor 2, a manual switch 3, a control switch 4, a discharge control unit 5, and the like. The electric motor 2 rotates receiving power supply from the battery pack 10. The manual switch 3 is opened/closed with a manual operation by a user. The control switch 4 is opened/closed in accordance with a control signal (a discharge control signal) outputted from the control unit 14. The discharge control unit 5 actually operates the control switch 4 to open/close based on the control signal.

The manual switch 3 and the control switch 4 are arranged in series with an electric power circuit 6 extending from the battery pack 10 to the electric motor 2 to open/close the electric power circuit 6. Due to this, the electric motor 2 rotates only when the both switches 3 and 4 are closed concurrently.

When a control signal to permit discharge (a discharge permission signal) is outputted from the control unit 14, the discharge control unit 5 closes the control switch 4 to enable power supply to the electric motor 2. In contrast, when the control signal to permit discharge is not outputted, i.e., when a control signal to prohibit discharge is outputted from the control unit 14, the discharge control unit 5 opens the control switch 4 to prohibit power supply to the electric motor 2.

Then, the control unit 14 determines whether or not the calculated usage fee is less than or equal to an already-paid usage fee (a balance amount) based on the payment information stored in the storage unit 13. Here, when the control unit 14 determines that the calculated usage fee is less than or equal to the already-paid usage fee, the control unit 14 outputs the control signal to permit discharge.

At this time, the control unit 14 subtracts the calculated usage fee from the already-paid usage fee (the balance amount) and updates the payment information. Also, the control unit 14 stores the updated payment information in the storage unit 13.

In contrast, when the control unit 14 determines that the calculated usage fee exceeds the already-paid usage fee, the control unit 14 stores information indicating an excess usage fee in the storage unit 13, and outputs the control signal to permit discharge until the excess usage fee exceeds a preset amount.

Then, when the excess usage fee has exceeded the preset amount, the control unit 14 outputs the control signal to prohibit discharge. On the other hand, when the discharge control unit 5 receives the control signal to prohibit discharge, the discharge control unit 5 indicates to that effect by lighting or blinking a warning lamp or the like (not shown).

The control unit 14 updates the excess usage fee (the payment information) stored in the storage unit 13 in synchronization with use of the electric power tool 1, and stores the updated payment information in the storage unit 13.

Incidentally, in order to calculate the usage fee, it is necessary to calculate the average discharge current per cycle to decide the billing rate. Therefore, the control unit 14 according to the present embodiment determines whether or not the usage fee is less than or equal to the already-paid usage fee (the balance amount) at the time after the voltage of the battery unit 11 becomes smaller than or equal to a predetermined voltage, which can be regarded as a deep discharge (hereinafter referred to as a deep discharge voltage), and also when the electric power tool 1 is stopped or charge is started.

In other words, since many users do not charge the battery pack 10 (the battery unit 11) until the battery pack 10 is brought into a deep discharge state from a fully charged state, in the present embodiment, a period from when the previous charge is completed till when the usage fee is calculated is defined as one cycle, and the average discharge current per cycle is decided based on the current value stored in the storage unit 12 to decide the billing rate. In a case where charging is forcibly terminated before the battery pack 10 is brought into a fully charged state, the time of forcible termination corresponds to “a time when the previous charge is completed”.

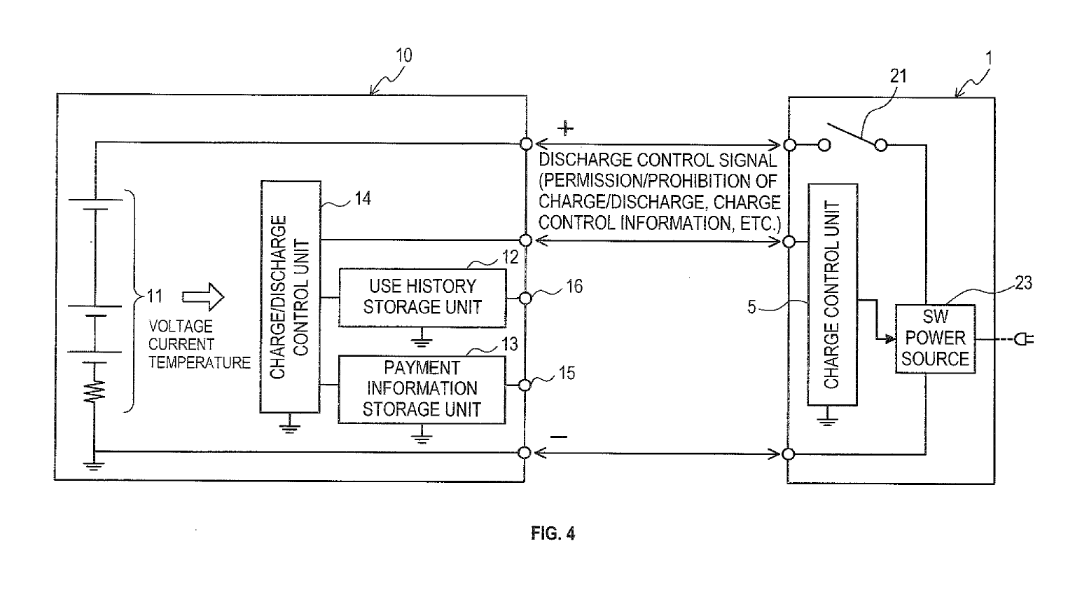

### 3.2. Charge Control (see FIG. 4)

A battery charger 20 includes a control switch 21, a charge control unit 22, a SW power source 23, and the like. The control switch 21 is opened/closed in accordance with a control signal outputted from the control unit 14. The charge control unit 22 actually operates the control switch 21 to open/close based on the control signal. The SW power source converts AC power supplied from a commercial power source into DC power source having a predetermined voltage.

When a control signal to permit charge (a charge permission signal) is outputted form the control unit 14, the charge control unit 22 closes the control switch 21 to enable power supply to the battery unit 11. In contrast, when the control signal to permit charge is not outputted, i.e., when a control signal to prohibit charge is outputted from the control unit 14, the charge control unit 22 opens the control switch 21 to prohibit power supply to the battery unit 11.

In principle, when the battery pack 10 is attached to the battery charger 20, the control signal to permit charge is outputted from the control unit 14, and voltage is applied to the battery unit 11, to thereby start charging the battery unit 11. Afterwards, when voltage of the battery unit 11 becomes greater than or equal to a voltage indicating a full charge (hereinafter referred to as a full charge voltage), it is considered that charging is completed, and the control signal to prohibit charge is outputted form the control unit 14.

However, in a case where a value of temperature or input current of the battery unit 11 becomes greater than or equal to a predetermined value, the control signal to prohibit charge is outputted from the control unit 14 to forcibly terminate the charging even when the voltage of the battery unit 11 is less than the full charge voltage.

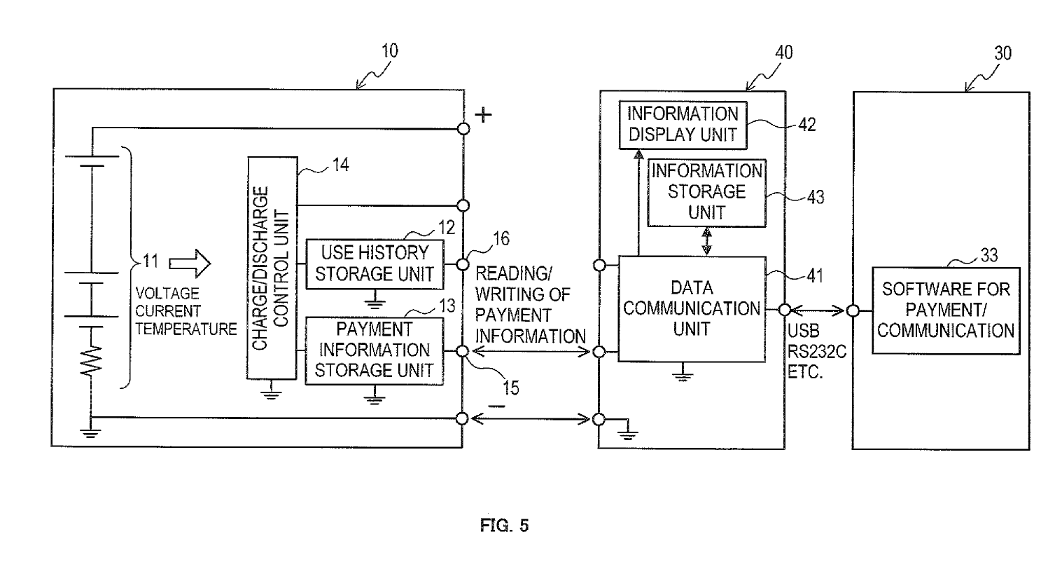

### 4. Accumulation Payment of Already-Paid Usage Fee and Payment of Excess Usage Fee (see FIG. 5)

In the battery pack 10, connection units 15 and 16 are provided to respectively connect the storage unit 13 and the storage unit 12 to the service terminal 40. The computer 30 can read/write (change) the payment information stored in the storage unit 13 via the data communication unit 41 in the service terminal 40 using an electronic payment program (shown as a software for payment/communication 33 in FIG. 5) installed in the computer 30.

Specifically, a data communication is performed between the computer 30 and a payment bank or the like, and when an electronic payment process is completed for an accumulation payment of the already-paid usage fee and a payment of the excess usage fee, a process signal to the effect that the payment has been completed is transmitted to the computer 30 from the payment bank or the like. At this time, the computer 30 changes the payment information stored in the storage unit 13 into payment information after completion of the electronic payment process via the data communication unit 41.

In the service terminal 40, an information display unit 42, an information storage unit 43, and the like are provided. The information display unit 42 displays contents of the electronic payment process and the payment information after completion of the electronic payment process. The information storage unit 43 stores history information of the payment information, and the like.

Incidentally, in the present embodiment, a reference potential of the service terminal 40 and a reference potential of the battery pack 10 (the storage unit 13) are matched to each other by conducting a negative electrode side of the battery pack 10 and a ground side of the service terminal 40, to thereby suppress a communication error from occurring.

### 5. Feature of Battery Pack and Electronic Payment System According to the Present Embodiment

In the present embodiment, as described above, at least as for the battery pack 10 in the electric power tool 1, a manufacturer (a distributor) can charge the usage fee in accordance with use of the electric power tool 1. Therefore, it becomes possible for the user to suppress the costs for purchasing and/or maintaining the electric power tool 1.

6. Correspondence Relationship between Matter to Define the Invention and the mbodiment

In the present embodiment, the detection unit 12A in the storage unit 12 corresponds to an example of a fee calculation information detection unit of the present invention.

### Second Embodiment

In the first embodiment, calculation of the usage fee, update of the payment information, and the like are performed during use of the electric power tool 1, i.e., during discharging. On the other hand, in the present embodiment, update of the payment information and the like are performed during charging of the battery pack 10.

Specifically, as shown in FIG. 4, when the battery pack 10 is attached to the battery charger 20, the control unit 14 decides the average discharge current per cycle and a type of the battery pack 10 (whether or not the battery pack 10 is of quick charge capable type) based on the information stored in the storage unit 12 as information for a period from the previous charge till the present charge. Afterwards, the control unit 14 decides the billing rate, and calculates the usage fee based on the used electric energy.

Next, the control unit 14 determines whether or not the calculated usage fee is less than or equal to the already-paid usage fee (the balance amount) based on the payment information stored in the storage unit 13. Here, when the control unit 14 determines that the calculated usage fee is less than or equal to the already-paid usage fee, the control unit 14 outputs a control signal to permit charge.

At this time, the control unit 14 subtracts the calculated usage fee from the already-paid usage fee (the balance amount) and updates the payment information. Also, the control unit 14 stores the updated payment information in the storage unit 13.

In contrast, when the control unit 14 determines that the calculated usage fee exceeds the already-paid usage fee, the control unit 14 stores information indicating an excess usage fee in the storage unit 13, and outputs the control signal to permit charge until the excess usage fee exceeds a preset amount.

Then, when the excess usage fee exceeds or has exceeded the preset amount, the control unit 14 outputs a control signal to prohibit charge, and indicates that charge is prohibited or stopped by lighting or blinking a warning lamp or the like (not shown) indicating to that effect.

The control unit 14 updates the excess usage fee (the payment information) stored in the storage unit 13 in accordance with a progression of charging, and stores the updated payment information in the storage unit 13.

Due to this, also in the present embodiment, at least as for the battery pack 10, it becomes possible to charge the usage fee in accordance with use of the electric power tool 1. Therefore, it becomes possible to suppress the costs for purchasing and/or maintaining the electric power tool 1.

### Third Embodiment

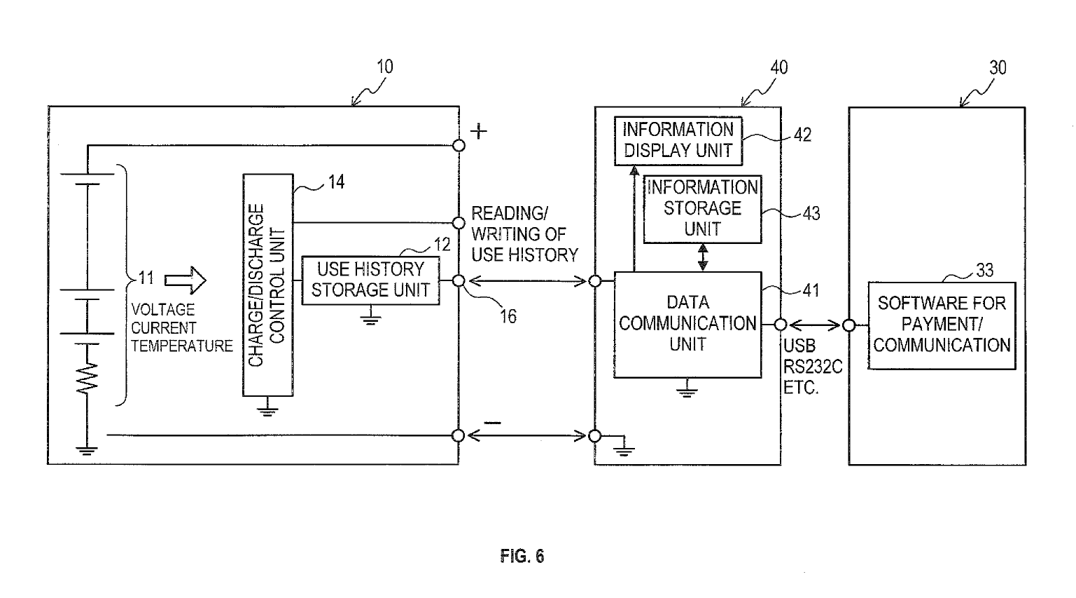

In the above embodiment, the battery pack 10 includes the storage unit 13. In contrast, in the present embodiment, the storage unit 13 is removed from the battery pack 10 as shown in FIG. 6. Moreover, in the present embodiment, the current value etc. and the type of the battery unit 11 stored in the storage unit 12 are read out by the computer 30 via the service terminal 40. Furthermore, in the present embodiment, the computer 30 calculates the usage fee and makes payment.

When an electric energy calculated based on the current value and the like stored in the storage unit 12 (the storage unit 12B) has exceeded a predetermined value, the control unit 14 according to the present embodiment indicates that the battery pack 10 should be connected to the service terminal 40 to make payment. Due to this, the excess usage fee is suppressed from excessively increasing.

### Other Embodiments

In the above embodiment, the usage fee is calculated per cycle and, therefore, the storage unit 12 detects the information (the current value and the like) for calculating the usage fee in accordance with use of the electric power tool 1 and stores the detected information. However, the present invention is not limited to this. For example, if the billing rate is constant, the control unit 14 may calculate the usage fee in synchronization with use of the electric power tool 1 (discharge of the battery pack 10) without storing the detected information.

In the above embodiment, the usage fee is decided with weights assigned in accordance with the use load of the electric power tool 1 (the discharge load of the battery pack 10). However, the present invention is not limited to this.

Furthermore, in the above embodiment, the use load of the electric power tool 1 (the discharge load of the battery pack 10) is decided based only on the average discharge current per cycle. However, the present invention is not limited to this, but the use load may be decided using, as a parameter, at least one of the discharge current, discharge voltage, and temperature of the battery unit during discharging.

In the above embodiment, the usage fee is decided using Wh, which is a summation of products of current and voltage. However, the present invention is not limited to this, but the usage fee may be decided based on at least one of Ah obtained by performing a summation of current, and the number of charges, for example.

In the above embodiment, the battery pack 10 is connected to the computer 30, which is a general-purpose computer for communication, via the service terminal 40. However, the present invention is not limited to this. For example, the battery pack 10, which is provided with a communication function, may be directly connected to a communications network, or may be directly connected to the computer 30 without involving the service terminal 40.

Besides, the present invention may be practiced in other embodiments as long as they match the spirit of the invention as set forth in the claims, and is not limited to the above-described embodiments.

1. A battery pack to be detachably attached to an electric power tool, the battery pack comprising:
a battery unit that can be charged and discharged, and supplies electric power to the electric power tool; and
a fee calculation information detection unit that detects an information for calculating a usage fee in accordance with use of the electric power tool.

2. The battery pack according to claim 1, further comprising:
a payment information storage unit in which a payment information about the usage fee is stored; and
a charge/discharge control unit that calculates the usage fee based on a detection result from the fee calculation information detection unit, and permits or prohibits at least either of a discharge operation and a charge operation of the battery unit based on the calculated usage fee and the payment information stored in the payment information storage unit.

3. The battery pack according to claim 2,
wherein the charge/discharge control unit determines whether or not the calculated usage fee has been already paid based on the payment information stored in the payment information storage unit, and decides to permit or prohibit the operation.

4. The battery pack according to claim 2,
wherein the charge/discharge control unit determines whether or not the calculated usage fee exceeds an already-paid amount based on the payment information stored in the payment information storage unit, and
wherein, when the charge/discharge control unit determines that the calculated usage fee exceeds the already-paid amount, an information indicating an excess usage fee is stored.

5. {Currently Amended) The battery pack according to claim 2, further comprising:
a connection unit for a readable/writable connection to the payment information storage unit.

6. An electronic payment system comprising:
the battery pack according to claim 2; and
a computer that performs an information communication with the battery pack.
